(19) United States
(12) Patent Application Publication
(10) Pub. No.: US 2009/0124126 A1
(43) Pub. Date: May 14, 2009

(54) SIM CARD CONNECTOR APPARATUS OF PORTABLE WIRELESS TERMINAL

(76) Inventors: Shi Yun CHO, Anyang-si (KR); Shin Hee Cho, Suwon-si (KR)

Correspondence Address: CHA & REITER, LLC, 210 ROUTE 4 EAST STE 103, PARAMUS, NJ, 07652, US

(21) Appl. No.: 12/174,696

(22) Filed: Jul. 17, 2008

(30) Foreign Application Priority Data
Nov. 14, 2007 (KR) 2007-0115827

(51) Int. Cl. H01R 13/648; H01R 24/00

(52) U.S. Cl. 439/607.31; 439/630

(57) ABSTRACT

A SIM card connector of a portable wireless terminal has a structure that forms a space thereunder using its lower edges to place electronic parts of a printed circuit board (PCB) within the space, so that the PCB can increase its space efficiency. The SIM card connector further forms an electromagnetic wave shield around the space, so that the electromagnetic wave shield can block electromagnetic waves generated from the electronic parts.

### CLAIM OF PRIORITY

This application claims priority under 35 U.S.C. §119 from an application entitled “SIM CARD CONNECTOR APPARATUS OF PORTABLE WIRELESS TERMINAL” filed in the Korean Intellectual Property Office on Nov. 14, 2007 and assigned Serial No. 2007-0115827, the contents of which are incorporated herein by reference in its entirety.

### BACKGROUND OF THE INVENTION

1. Field of the Invention

The present invention relates to a portable wireless terminal and a SIM card connector apparatus of a portable wireless terminal. More particularly, the present invention relates to a SIM card connector, size reduction and electromagnetic shielding.

2. Description of the Related Art

In portable wireless terminals, communication methods are typically divided into a global system for mobile communication (GSM) method and a code division multiple access (CDMA) method. The GSM method uses a subscriber identity module (SIM) card in portable wireless terminals to support compatibility among various network service subscribers. The SIM card includes most of the necessary information for operating a portable wireless terminal.

More particularly, the SIM card encrypts and stores data that includes information about phone numbers and network numbers, etc. as well as subscriber's private information such as passwords, etc. The portable wireless terminal provides a SIM card connector with the main PCB thereof and is designed such that the SIM card can be electrically connected to the SIM card connector.

FIG. 1 shows a plan view of a main printed circuit board (PCB) 3 of a portable wireless terminal, onto which a conventional SIM card connector 1 is placed. The main PCB 3 includes a plurality of electronic parts 4 arranged on an upper surface of the PCB. A SIM card connector 1 has a lower side that is closely and tightly secured to the main PCB 3 by soldering. The SIM card connector 1 includes contacts that are electrically connected to the SIM card 2, and wherein the contacts are also electrically connected to the controller of the portable wireless terminal through the PCB. In other words, as the SIM card 2 is placed in or removed from the SIM card connector 1, it is also electrically connected to or disconnected from the SIM card connector 1. However, the conventional SIM card connector 1 requires a relatively wide placement area in the PCB.

In recent years, portable wireless terminals have been manufactured in smaller sizes with a focus on aesthetics because their design affects sale figures. Due to convergence technology that provides a variety of functions, the number of electronic parts, to be installed to the PCB of the portable wireless terminals, is gradually increasing.

However, the conventional SIN card connector apparatus must maintain its size due to the SIM card, whose size is already defined as the standard. That is, it has a relatively large size compared to the small-sized portable wireless terminals. The conventional SIM card connector must take up a wide area on the PCB. Furthermore, the conventional SIM card connector does not allow for an electronic part to be placed on the upper surface of the PCB, i.e., there beneath, thereby wasting the surface area space of the PCB. The lower side of the conventional SIM card connector does not have any other function except that it is engaged with the PCB. Therefore, in the event that the integrity of electronic parts is increased, the connected area between the PCB and the SIM card connector must be used to place electronic parts upon or utilized for a particular purpose.

### SUMMARY OF THE INVENTION

The present invention provides a technique that can secure a space between the PCB and the SIM card connector in a portable wireless terminal and allow arrangement of electronic parts in the secured space.

In accordance with an exemplary embodiment of the present invention, the present invention provides a SIM card connector apparatus of a portable wireless terminal including: an upper side including contacts, on or from which a SIM card is placed or removed; and a lower side including protrusions that forms a space thereunder. The lower side of the SIM card connector apparatus is electrically connected to the SIM card, when the SIM card is placed in the upper side through the contacts.

In accordance with another exemplary embodiment of the present invention, the present invention provides a SIM card connector apparatus of a portable wireless terminal including: an upper side including contacts, on or from which a SIM card is placed or removed; and a lower side on which an electromagnetic wave shield is formed, wherein the lower side is electrically connected to the SIM card when the SIM card is arranged in the upper side through the contacts and is attached onto an imbedded PCB including electronic parts through the electromagnetic wave shield.

### BRIEF DESCRIPTION OF THE DRAWINGS

The features and advantages of the present invention will be more apparent from the following detailed description in conjunction with the accompanying drawings, in which:

FIG. 1 is a plan view of a PCB onto which a conventional SIM card connector is placed;

FIG. 2A is a plan view illustrating a SIM card connector according to an exemplary embodiment of the present invention;

FIG. 2B is a cross-sectional view illustrating a SIM card connector according to an exemplary embodiment of the present invention;

FIG. 3 is a cross-sectional view illustrating a PCB onto which a SIM card connector according to a first exemplary embodiment of the present invention is placed;

FIG. 4 is a plan view illustrating a PCB onto which a SIM card connector according to a first exemplary embodiment of the present invention is placed;

FIG. 5 is a cross-sectional view depicting a SIM card connector according to a second exemplary embodiment of the present invention; and

FIG. 6 is a cross-sectional view depicting a PCB onto which a SIM card connector according to a second exemplary embodiment of the present invention is placed.

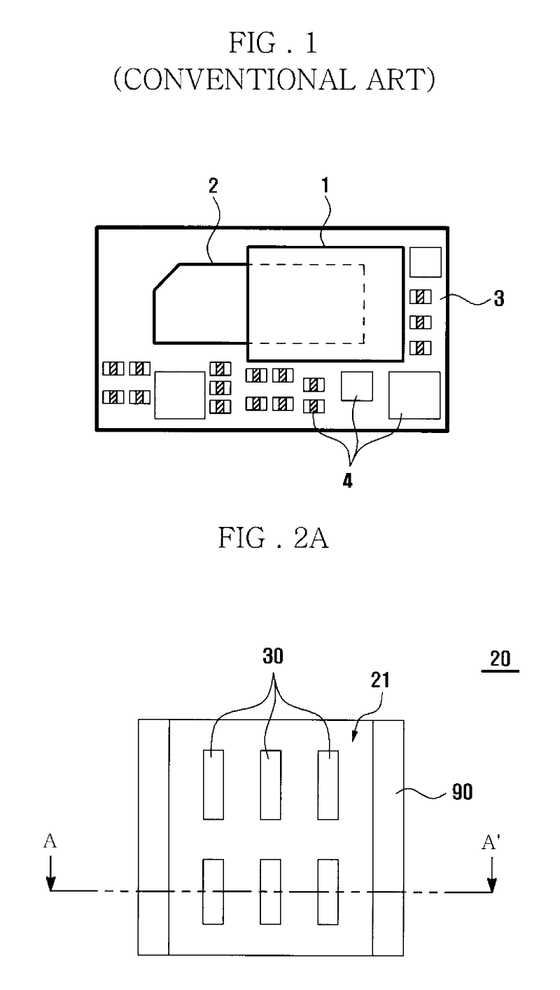

### DETAILED DESCRIPTION

Hereinafter, exemplary embodiments of the present invention are described in detail with reference to the accompanying drawings. The same reference numbers are used throughout the drawings to refer to the same or similar parts. For the purposes of clarity and simplicity, detailed descriptions of well-known functions and structures incorporated herein may be omitted to avoid obscuring appreciation of the subject matter of the present invention by a person of ordinary skill in the art.

The terms or words described in the present description and the claims should not be limited by a general or lexical meaning, instead should be analyzed as a meaning and a concept through which the inventor defines and describes the present invention. Therefore, one skilled in the art will understand that the exemplary embodiments disclosed in the description and configurations illustrated in the drawings are only preferred examples, instead there may be various modifications, alterations, and equivalents thereof to replace the exemplary embodiments that lie within the spirit of the invention and the scope of the appended claims.

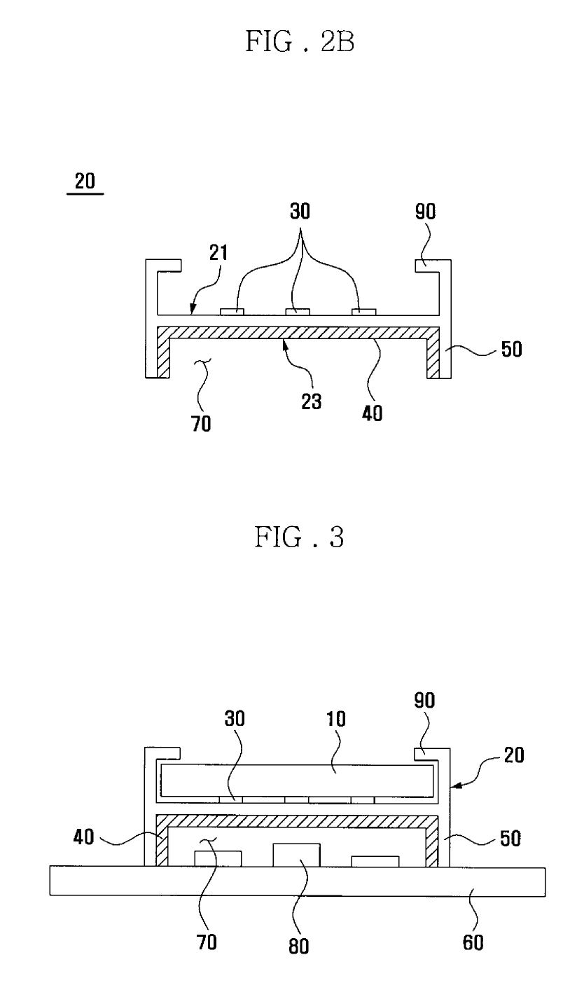

FIGS. 2A to 4 show a SIM card connector apparatus of a portable wireless terminal according to a first exemplary embodiment of the present invention. Referring to FIG. 2A, the SIM card connector 20 includes an upper side 21 on which at least one or more contacts 30 are formed which are electrically connected to a SIM card 10 (FIG. 3).

As shown in FIG. 2B, which illustrates a cross-sectional view taken along line A-A′ in FIG. 2A, the SIM card connector 20 includes a lower side 23 whose both edges are protrudent, called a protrusion 50. That is, the lower side 23 forms a space 70 underneath the SIM card connector 20. The space 70 generally defined by the protrusions on lower side 23 of SIM card connector 20 forms an electromagnetic wave shield 40 thereon to block electromagnetic waves generated in the space 70. The electromagnetic wave shield 40 is formed on the lower side 23 by attaching, coating, or spaying a metal material to provide an electromagnetic wave shield. The electromagnetic wave shield 40 is electrically connected to the ground terminal of the PCB 60.

The protrusion 50 extends or protrudes at both edges of the lower side 23 of the SIM card connector 20, thereby allowing for the space 70 underneath the SIM card connector 20. The protrusion 50 may be formed by a variety of methods, such as a molding.

FIG. 3 is a cross-sectional view illustrating a PCB 60 onto which a SIM card connector 20 is arranged.

The SIM card connector 20 mounts the SIM card 10 therein and, accordingly, the contacts 30 of the SIM card connector 20 are electrically connected to contacts of the SIM card 10, which are not shown. The SIM card 10 is guided by guiding parts of the SIM card connector 20, so that it is mounted on the SIM card connector 20. It should be understood that the guiding parts 90 can be implemented by a variety of structures. Electronic parts 80 mounted on the upper side of the PCB can be located in the space 70 formed by the protrusions 50 underneath the SIM card connector 20. That is, the space 70 increases the use of the PCB 60 to permit more electronic components to be installed on the PCB than a conventional PCB/SIM connector arrangement. In recent years, since electronic parts are becoming increasing smaller in size, for example in area and height, the SIM card connector 20 also reduces the height of the electronic parts.

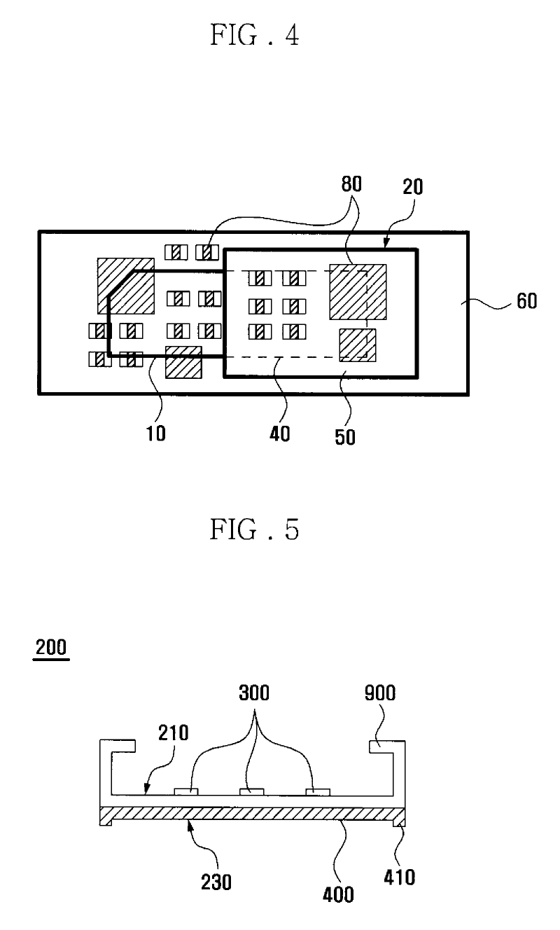

FIG. 4 is a perspective plan view illustrating a PCB onto which a SIM card connector 20 is placed. As shown in FIG. 4, a plurality of electronic parts 80, are arranged under the SIM card 10 and the SIM card connector 20, and are mounted on the upper side of the PCB. Accordingly, the structure of the present invention increases the available amount of space in the PCB 60. Additionally, since the electromagnetic wave shield 40 is on the wall of the space 70 of the SIM card connector 20, electromagnetic waves generated from the electronic parts 80 located within the space 70 can be blocked. Thus, the present invention provides the additional advantage of preventing emission of the electromagnetic waves. Consequently, the SIM card connector 20 according to the present invention can extend over an area that allows electronic parts 80 to be mounted on the PCB 60 in the area normally required for the SIM card connector, and block the electromagnetic waves from the mounted electronic parts 80. That is, the structure of the SIM card connector 20 is beyond. In particular, when the SIM card connector 20 places RF devices, which emit a large amount of electromagnetic waves, within the space 70 thereof, the electromagnetic wave blocking effect is highly effective.

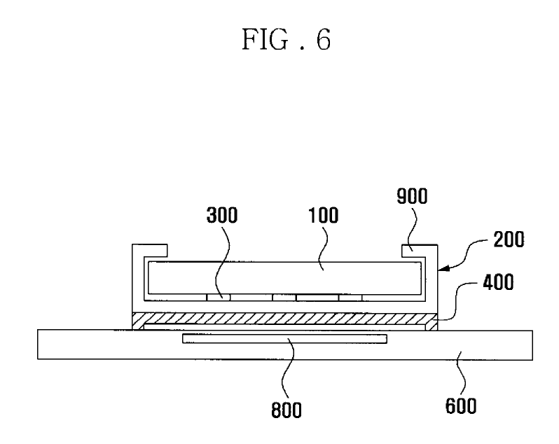

FIGS. 5 and 6 are a cross-sectional views depicting a SIM card connector according to a second exemplary embodiment of the present invention. The SIM card connector 200 is adapted for connection an imbedded PCB 600. Unlike the SIM card connector 20 of the first exemplary embodiment of the present invention, the SIM card connector 200 does not have a protrusion. The lower side 230 of the SIM card connector 200 is attached to the upper side of the imbedded PCB 600 via an electromagnetic wave shield 400.

The imbedded PCB 600 is designed to allow electronic parts 800 to be located therewithin, thereby increasing the space use of the PCB that would not be possible with the conventional SIM card connector. The SIM card connector 200 in this example includes a guiding part 900, an upper side 210 including contacts 300 that are electrically connected to contacts (not shown) of the SIM card 100 and a lower side 230 on which an electromagnetic wave shield 400 is formed. The SIM card connector 200 may be attached, for example, on the upper side of the imbedded PCB 600 by soldering only the edge 410 thereof or by any other fixing methods that use the lower surfaces thereof. The electromagnetic wave shield 400 of the SIM card connector 200 is electrically connected to the ground terminal of the imbedded PCB 600.

FIG. 6 is a cross-sectional view depicting an imbedded PCB 600 onto which a SIM card connector 200 according to a second embodiment of the present invention is placed. The imbedded PCB 600 includes electronic parts 800. The electromagnetic wave shield 400 is attached to the imbedded PCB 600 by soldering the edges 410 thereof. The imbedded electronic parts 800 can be arranged in the PCB in areas that normally was reserved for the SIM connector attachment in a conventional device.

Although the edges 410 of the electromagnetic wave shield 400 appears to protrude slightly in FIG. 6, their protrudent portions do not constitute a substantial protrusion, but rather comprises an area of soldering. The SIM card connector 200 with the electromagnetic wave shield 400 is mounted right above the electronic parts 800, thereby efficiently blocking the electromagnetic waves generated from the electronic parts 800.

As described above, the SIM card connector apparatus of portable wireless terminal, according to the present invention, provides secure the use of space on the PCB previously reserved for arrangement of the SIM connector, and efficiently blocks electromagnetic waves emitted from the electric parts by using the lower side of the SIM card connector, which was not utilized in the conventional technique. Also the SIM card connector apparatus forms an electromagnetic wave shield within the space, thereby increasing the usage space of the PCB and efficiently blocking electromagnetic waves generated from the electronic parts.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A SIM card connector apparatus of a portable wireless terminal comprising:
an upper side sized for receiving at least a portion of a SIM card, said upper side including contacts arranged for electrical connection with the SIM card; and
a lower side including protrusions forming a space thereunder, wherein the lower side is electrically connected to the SIM card arranged in the upper side.

2. The apparatus of claim 1, wherein the lower side comprises an electromagnetic wave shield arranged within the formed space.

3. The apparatus of claim 2, wherein the electromagnetic wave shield includes a metallic surface.

4. The apparatus of claim 2, wherein the protrusions are attached to a printed circuit board (PCB).

5. The apparatus of claim 1, wherein the protrusions are project from the edges of the lower side.

6. The apparatus of claim 1, wherein the upper side further comprises guiding parts for guide a SIM card, said guiding parts being arranged along opposing edges of the connector.

7. The apparatus of claim 4, wherein the PCB comprises a plurality of electronic parts arranged in the space formed by the lower side and connected to the PCB.

8. The apparatus of claim 4, wherein the electromagnetic wave shield is connected to a ground terminal of the PCB.

9. A SIM card connector apparatus of a portable wireless terminal comprising:
an upper side sized for receiving at least a portion of a SIM card and including contacts arranged for electrical connection with the SIM;
a lower side on which an electromagnetic wave shield is formed; and
an imbedded PCB on which the lower side of the SIM card connector is arranged, said imbedded PCB including electronic parts therein,
wherein said lower side is attached to the upper side of an imbedded PCB via said electromagnetic wave shield, and wherein the lower side is electrically connected to the SIM card through the contacts on the upper side.

10. The apparatus of claim 9, wherein the PCB includes a ground terminal, and wherein the electromagnetic wave shield is connected to the ground terminal of the PCB.

11. The apparatus of claim 10, wherein at least a portion of the imbedded electronic parts can be arranged in the PCB in the space defined by the lower side of the SIM card connector.

12. The apparatus of claim 11, wherein the electromagnetic wave shield is directly above the electronic parts for blocking electromagnetic waves generated from the electronic parts imbedded in the PCB.

13. The apparatus of claim 9, wherein the upper side further comprises guiding parts for guide a SIM card, said guiding parts being arranged along opposing edges of the connector.
